(19) United States
(12) Patent Application Publication
(10) Pub. No.: US 2018/0262732 A1
(43) Pub. Date: Sep. 13, 2018

(54) DISPLAY APPARATUS, METHOD FOR CONTROLLING THE SAME, AND NON-TRANSITORY STORAGE MEDIUM

(71) Applicant: CANON KABUSHIKI KAISHA, Tokyo (JP)

(72) Inventors: Hirofumi Urabe, Tokyo (JP); Sosuke Kagaya, Tokyo (JP)

(21) Appl. No.: 15/902,713

(22) Filed: Feb. 22, 2018

(30) Foreign Application Priority Data
Mar. 10, 2017 (JP) 2017-046562

(51) Int. Cl. H04N 9/64; G11B 31/00; H04N 5/232; H04N 5/775; G06T 19/20

(52) U.S. Cl. CPC H04N 9/646; G11B 31/006; G06T 19/20; H04N 5/775; H04N 5/23293

(57) ABSTRACT

A display apparatus includes a display unit, a plurality of input terminals to input a plurality of image signals, and a control unit to control the display unit. The display unit displays an image. Where at least one of the plurality of image signals is of a Raw Image Format (RAW) image, the control unit controls the display unit to display the image based on an image signal input to an input terminal among the plurality of input terminals that corresponds to a first number. Where none of the plurality of image signals is of a RAW image, the control unit controls the display unit to display the image based on an image signal input to an input terminal among the plurality of input terminals that corresponds to a second number.

### BACKGROUND OF THE INVENTION

### Field of the Invention

The present disclosure relates to a display apparatus including a plurality of input terminals, a method for controlling the display apparatus, and a non-transitory storage medium storing a program for realizing this control method.

### Description of the Related Art

Conventionally, during a process of producing a video image, sometimes, an image in the middle of being captured has been confirmed on a display apparatus connected to an imaging apparatus while an object has been being imaged by the imaging apparatus such as a camera. In recent years, the improvement of functions of imaging apparatuses and display apparatuses has led to an increase in occasions of handling an image at a high resolution compared to before.

Image data formats supportable by the imaging apparatuses include a Raw Image Format (RAW) format, a Joint Photographic Experts Group (JPEG) format, and the like. Some of the imaging apparatuses output an image in the RAW format (a RAW image) to save labor of processing (image processing) other than recording processing when capturing (recording) the image, and output an image (a non-RAW image) generated by performing development processing on the recorded RAW image when playing back the image.

Further, the number of transmission paths for use in transmission may be different according to a data format of an image output from the imaging apparatuses. For example, an image at a resolution of 3840×2160 and a frame rate of 60 P can be transmitted via two transmission paths if this image is the image in the RAW format, while having to be transmitted with use of four transmission paths if this image is the image in the non-RAW format.

When such an imaging apparatus transmits the image with use of the plurality of transmission paths, the display apparatus connected to the imaging apparatus generates an image for a display with use of image signals acquired via a plurality of input terminals corresponding to the plurality of transmission paths, and then displays the generated image.

Japanese Patent Application Laid-Open No. 2008-278381 discloses that a selector apparatus discussed therein switches the input terminal according to a playback state of a connected external apparatus.

### SUMMARY OF THE INVENTION

According to an aspect of the present invention, a display apparatus includes a display unit configured to display an image, a plurality of input terminals configured to input a plurality of image signals, and a control unit configured to control the display unit, wherein, in a case where at least one of the plurality of image signals is of a Raw Image Format (RAW) image, the control unit controls the display unit to display the image based on an image signal input to an input terminal among the plurality of input terminals that corresponds to a first number, and wherein, in a case where none of the plurality of image signals is of a RAW image, the control unit controls the display unit to display the image based on an image signal input to an input terminal among the plurality of input terminals that corresponds to a second number.

Further features of the present invention will become apparent from the following description of embodiments with reference to the attached drawings.

### BRIEF DESCRIPTION OF THE DRAWINGS

FIG. 1 is an apparatus configuration diagram illustrating a configuration of a display system including a display apparatus, an output apparatus, and cables.

FIG. 2A is a block diagram illustrating functional blocks of the output apparatus. FIG. 2B is a block diagram illustrating functional blocks of the display apparatus.

FIG. 3 schematically illustrates a determination table.

FIG. 4 is a flowchart illustrating a display image output flow performed by the display apparatus.

### DESCRIPTION OF THE EMBODIMENTS

In the following description, an embodiment will be described with reference to the drawings. However, the scope of the subject matter of the terms of the claims is not be limited by the embodiment cited as one example below. The contents described in the present disclosure and the drawings are merely one example and do not limit the scope. These contents can be modified in various manners and are not intended to exclude these modifications from the scope. In other words, all of configurations formable by combining each embodiment and a modification thereof are included in the present disclosure.

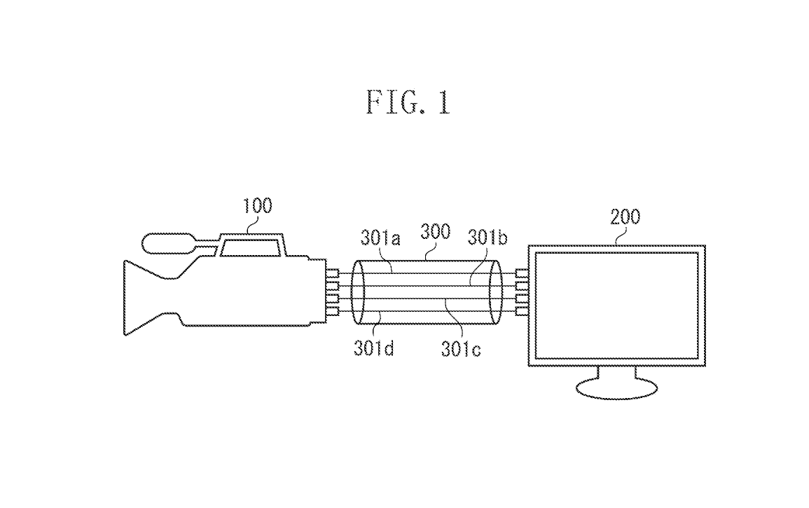

FIG. 1 is an apparatus configuration diagram illustrating a configuration of a display system including a display apparatus 200, an output apparatus 100 that outputs a video signal to the display apparatus 200, and cables 300 connecting the output apparatus 100 and the display apparatus 200 to each other.

The output apparatus 100 is an output apparatus that outputs an image to the display apparatus 200 via the plurality of cables 300. For example, assume that the output apparatus 100 is an imaging apparatus such as a digital camera. The output apparatus 100 stores an image in a RAW Image Format (a RAW format) (a RAW image) in a storage medium provided to the output apparatus 100. Further, assume that the output apparatus 100 outputs the image in the RAW format (the RAW image) while capturing the image. Further, assume that the output apparatus 100 outputs an image in a format in a non-RAW format (a non-RAW image) generated by developing the RAW image stored in the storage medium when outputting the image stored in the output apparatus 100.

Further, the output apparatus 100 includes a plurality of output terminals for transmitting an image at a high resolution. For example, assume that the output apparatus 100 includes four output terminals. A video output apparatus uses a different number of transmission paths between when outputting the image with use of a RAW signal and when outputting the image with use of a non-RAW signal. For example, suppose that the video output apparatus transmits an image at a progressive (60 P) frame rate of 60 Hz and a resolution of 3840 as the number of effective pixels in a horizontal direction and 2160 as the number of effective lines in a vertical direction (3840×2160). If transmitting this image as the RAW image, the output apparatus 100 generates two RAW images at the resolution of 3840×2160 and a frame rate of 30 P, and transmits them. At this time, the output apparatus 100 transmits the images with use of at least two output terminals among the four output terminals.

On the other hand, if transmitting this image as the non-RAW image, for example, the output apparatus 100 generates non-RAW images at a resolution of 1920×1080 and the frame rate of 60 P by dividing the image into four images, and transmits them. At this time, the output apparatus 100 transmits respective signals from the four output terminals. A method by which the output apparatus 100 transmits the images will be described below.

The output apparatus 100 may be a recorder connected to an external imaging apparatus and including a storage medium. Assume that the recorder outputs the RAW image acquired from the imaging apparatus if recording a video image acquired from the imaging apparatus, and outputs the non-RAW image if outputting the image stored in the storage medium.

The display apparatus 200 is a display apparatus that includes a plurality of input terminals and displays an image based on a plurality of input video signals. For example, assume that the display apparatus 200 is a liquid crystal display. The display apparatus 200 may be a projector that projects the image on a screen. For example, assume that the display apparatus 200 includes four input terminals.

The cables 300 are interface cables for connecting the output apparatus 100 and the display apparatus 200 to each other and transmitting the video signal. The cables 300 include transmission paths according to the output terminals of the output apparatus 100 and the input terminals of the display apparatus 200. For example, assume that the cables 300 include four transmission paths 301a to 301d.

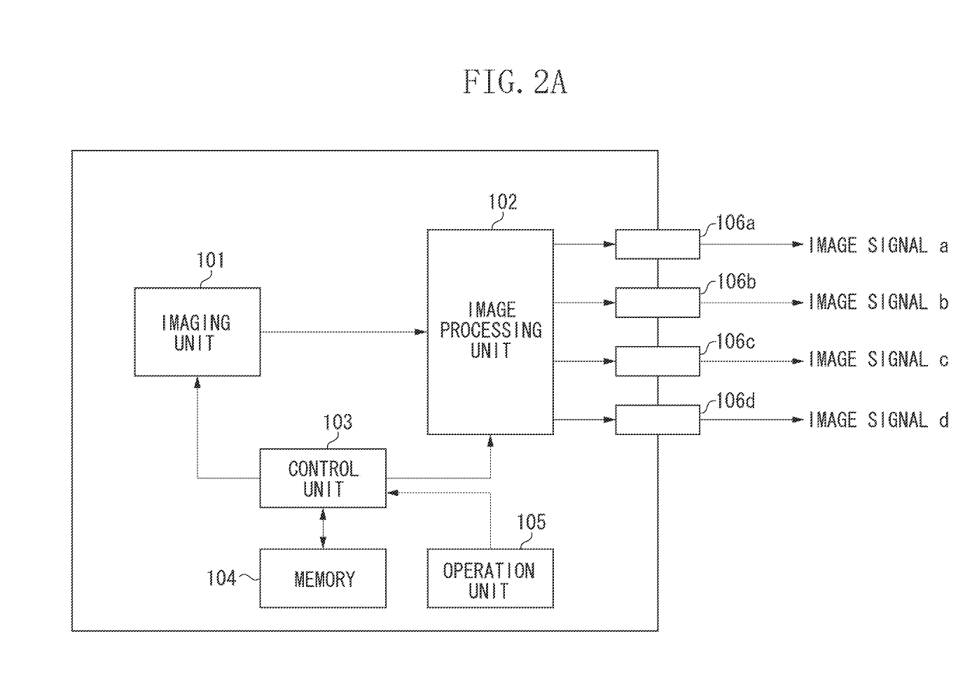

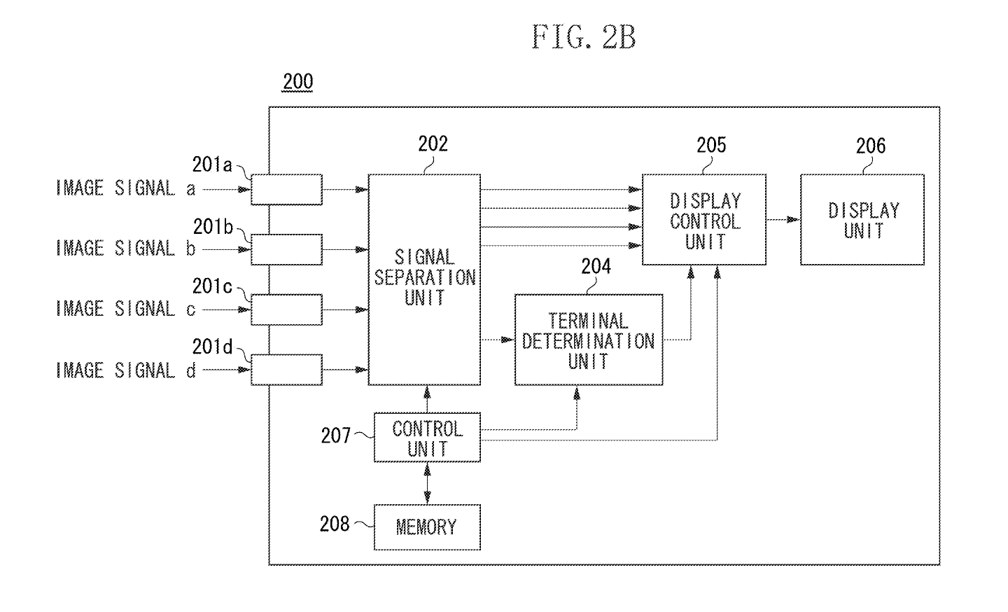

FIGS. 2A and 2B are block diagrams illustrating functional blocks of the output apparatus 100 and the display apparatus 200, respectively. FIG. 2A is the block diagram illustrating the functional blocks of the output apparatus 100. The output apparatus 100 includes an imaging unit 101, an image processing unit 102, a control unit 103, a memory 104, an operation unit 105, and output terminals 106a to 106d.

The imaging unit 101 is an imaging unit that outputs an original image acquired by imaging an object. The imaging unit 101 includes an optical system that includes a lens, an image sensor that detects light transmitted through the optical system, an imaging control circuit that controls the optical system and the image sensor, and an output circuit that outputs an original video signal based on a signal output from the image sensor. The imaging unit 101 is similar to an imaging unit included in an imaging apparatus such as a conventional digital camera, and therefore a detailed description thereof will be omitted herein.

The imaging unit 101 acquires RAW recording setting information, resolution setting information, and frame rate setting information from the control unit 103. The RAW recording setting information is information indicating whether to output the acquired original image as the RAW image. The resolution setting information is information indicating a resolution of the image to be output. The frame rate setting information is information indicating a speed (a frame rate) at which the image is output from the imaging unit 101. The imaging unit 101 outputs the original image acquired by the image sensor to the image processing unit 102 at the set frame rate as the RAW image or the non-RAW image having the set resolution based on these pieces of setting information.

The image processing unit 102 performs processing for generating an image signal to be output from each of the output terminals 106a to 106d based on the image output from the imaging unit 101. The image processing unit 102 determines a frame rate and the number of pixels (a resolution) of a signal into which the image is converted according to a bandwidth transmittable through the transmission path formed by the output terminal 106, an input terminal 201, and the cable 300.

For example, assume that one transmission path can transmit the RAW image having the resolution of 3840×2160 at the frame rate of 30 P. If the RAW image having the resolution of 3840×2160 is output at the frame rate of 30 P from the imaging unit 101, the RAW image can be transmitted via each of the transmission paths without being converted, and therefore the image processing unit 102 outputs same image signals to the output terminals 106a to 106d.

On the other hand, if the RAW image having the resolution of 3840×2160 is output at the frame rate of 60 P from the imaging unit 101, the image processing unit 102 divides the RAW image into two RAW signals corresponding to two RAW images at the resolution of 3840×2160 and the frame rate of 30 P, and outputs them. Assume that, at this time, the image processing unit 102 outputs a RAW signal A to the output terminals 106a and 106c and outputs a RAW signal B to the output terminals 106b and 106d.

On the other hand, assume that, if the imaging unit 101 outputs the non-RAW image at the resolution of 3840×2160 after RAW development, the image processing unit 102 divides the non-RAW image into four non-RAW images at the resolution of 1920×1080, and outputs them to the output terminals 106a to 106d, respectively. Further, assume that, if outputting (playing back and outputting) the image stored in the memory 104, the image processing unit 102 outputs the non-RAW image.

For example, assume that, if outputting the image as the RAW image, the image processing unit 102 outputs the image having a gradation value of each pixel in a Red, Green, and Blue (RGB) format. On the other hand, assume that, if outputting the image as the non-RAW image, the image processing unit 102 outputs the image having the gradation value of each pixel in a one-luminance and two-chrominance (YCC) format.

Further, the image signal output from the image processing unit 102 contains image data indicating each pixel value in the image and metadata indicating a feature of the image that is added to the image data. For example, assume that the image processing unit 102 configures the image signal in such a manner that the metadata is transmitted between transmission of image data corresponding to one line and transmission of image data corresponding to the next one line in the image.

The metadata contains, for example, information indicating a resolution of the original image, information indicating a frame rate, information indicating the format for specifying the color of the pixel, information indicating a time code expressing a time at which the image is acquired, information indicating a model of the output apparatus 100, and information indicating a state of the output apparatus 100. The information indicating the format for specifying the color of the pixel is information indicating, for example, whether the pixel value written in the image signal is expressed in R (red), G (green), and B (blue), or luminance (Y), chrominance-red (Cr), and chrominance-blue (Cb).

Assume that, if dividing the original image and then outputting the image signal from each of the output terminals 106a to 106d, the image processing unit 102 adds terminal information indicating an order of the image signal to be output individually with respect to the image signal to be output from each of the output terminals 106a to 106d as the metadata. The order of the image signal is information necessary for an apparatus that receives the plurality of image signals to combine the plurality of image signals when displaying the original image. For example, if one image is transmitted after being divided into four images in the form of a squarely quartered grid, the order of the image signal is order information indicating a position of each of the image signals in the original image. On the other hand, if the original image output at the frame rate of 60 P is output as two image signals at the frame rate of 30 P by being alternately thinned out, the order of the image signal is information indicating an order when the two image signals are arranged again in a temporal direction.

The control unit 103 is an arithmetic processing circuit that executes a program stored in the memory 104 to control the imaging unit 101 and the image processing unit 102. For example, assume that the control unit 103 is a central processing unit (CPU). The control unit 103 performs processing for controlling an operation of the imaging unit 101 according to imaging setting information such as the RAW recording setting information, the resolution setting information, and the frame rate setting information stored in the memory 104. These pieces of setting information can be set by the user via a not-illustrated input interface.

The memory 104 is a storage medium that stores therein the program and a parameter used for the control unit 103 to control each of the functional blocks. The memory 104 is a nonvolatile storage medium such as a hard disk or a volatile storage medium such as a semiconductor memory.

The operation unit 105 is a user interface used for the user to input, for example, the setting information of the RAW recording setting, the frame rate, the resolution, and the like, and an instruction to record or play back an image.

The output terminals 106a to 106d are each an output terminal for outputting the image signal output from the image processing unit 102 outward. For example, assume that the output terminals 106a to 106d are connectors in compliance with the Serial Digital Interface (SDI) standard. Assume that the image signals output from the output terminals 106a to 106d are image signals a to d, respectively.

FIG. 2B is a block diagram illustrating the functional blocks of the display apparatus 200. The display apparatus 200 includes input terminals 201a to 201d, a signal separation unit 202, a terminal determination unit 204, a display control unit 205, a display unit 206, a control unit 207, and a memory 208.

The input terminals 201a to 201d are each an input terminal for receiving the image signal input from the output apparatus 100 via the cable 300. For example, assume that the input terminals 201a to 201d are connectors in compliance with the SDI standard.

The signal separation unit 202 is a receiver capable of receiving the plurality of video signals. The signal separation unit 202 outputs the image signals a to d to the display control unit 205, and outputs the metadata added to each of the image signals a to d to the terminal determination unit 204.

The terminal determination unit 204 is a circuit that determines an input terminal for acquiring an image signal to be used to generate a display image according to whether the input image signal is the RAW image. The terminal determination unit 204 acquires the information indicating the model of the output apparatus 100 that is contained in the metadata. Further, the terminal determination unit 204 acquires a method for determining whether the image signal output from the output apparatus 100 is the RAW image based on the acquired information indicating the model of the output apparatus 100.

The terminal determination unit 204 determines whether the input image signal is the RAW image based on the acquired metadata. For example, assume that the terminal determination unit 204 determines whether the input image signal contains image data in which the pixel value is specified in RGB, based on the information indicating the format for specifying the color of the pixel that is contained in the metadata.

Then, the terminal determination unit 204 determines the input terminal for acquiring the image signal to be used to generate the display image according to whether the input image signal is the RAW image. More specifically, based on the information indicating the model of the output apparatus 100 that is contained in the metadata, the terminal determination unit 204 determines that a predetermined input terminal is the input terminal for acquiring the image signal to be used to generate the display image, according to whether the input image signal is the RAW image.

The terminal determination unit 204 acquires the information indicating the order of each of the image signals from the acquired metadata, and outputs the acquired information to the display control unit 205.

The terminal determination unit 204 outputs the determined result to the display control unit 205.

The display control unit 205 selects the input terminal to be used to generate the display image, based on the result of the determination by the terminal determination unit 204, and controls the display unit 206 in such a manner that an image is displayed based on the display image generated with use of the image signal input via the selected input terminal. Further, if the RAW image is input, the display control unit 205 performs the RAW development processing to generate the display image.

The display unit 206 displays the image on a screen based on the display image. For example, assume that the display unit 206 is a liquid crystal display including a liquid crystal panel and a backlight. The display unit 206 may be the projector that displays the image by projecting the image on the screen.

The control unit 207 is an arithmetic processing circuit that executes a program stored in the memory 208 to control each of the functional blocks of the display apparatus 200. For example, assume that the control unit 207 is a CPU. The control unit 207 can control the display on the display unit 206 including a display layout according to which the display unit 206 displays the image.

For example, assume that the signal separation unit 202, the terminal determination unit 204, and the display control unit 205 are formed by electronic circuits different from one another, respectively, and operations thereof are controlled by the control unit 207. A function or functions of one or more functional block(s) among the signal separation unit 202, the terminal determination unit 204, and the display control unit 205 can also be realized by the execution of the program by the control unit 207.

The memory 208 is a storage medium that is used for the control unit 207 to store the program and a parameter to control each of the functional blocks. Further, assume that the memory 208 stores therein a determination table indicating a correspondence between the model of the output apparatus 100 and the method for determining whether the output image signal is the RAW image. The memory 208 is a nonvolatile storage medium such as a hard disk or a volatile storage medium such as a semiconductor memory.

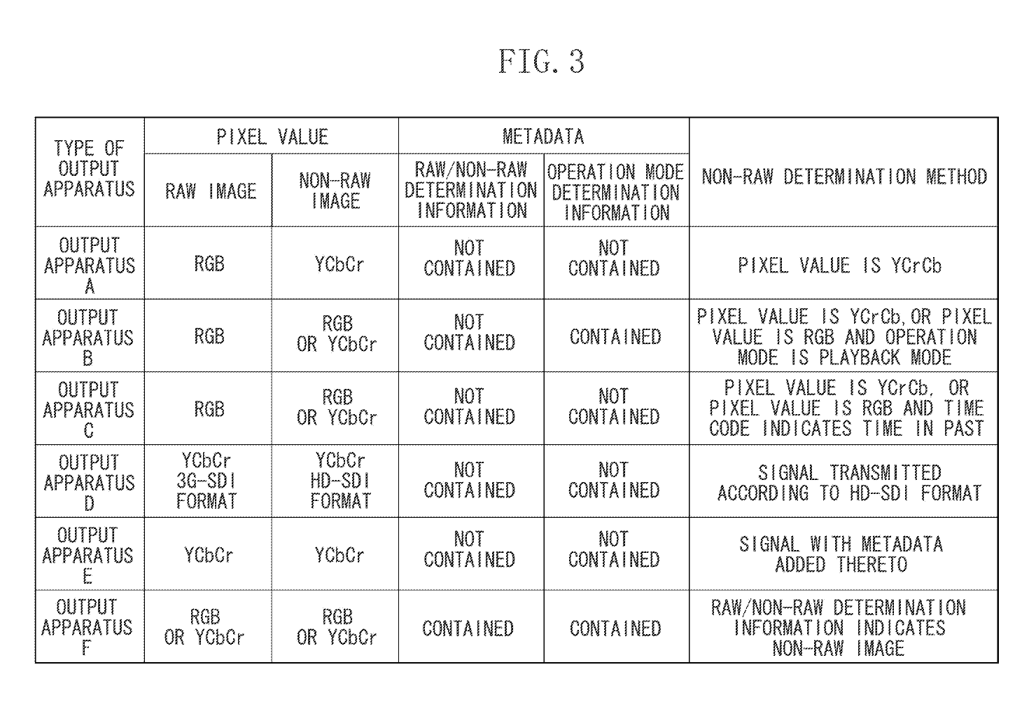

FIG. 3 schematically illustrates the determination table. For example, assume that information for determining that an image signal output from each of output apparatuses A to F is the non-RAW image is associated with the output apparatuses A to F in the determination table. The output apparatuses A to F each indicate a type of the output apparatus 100.

Assume that the output apparatus A specifies the pixel value of each pixel in the RGB format if outputting the image signal of the RAW image, and specifies the pixel value of each pixel in the YCbCr format if outputting the image signal of the non-RAW image. Further, assume that the image signal output from the output apparatus A does not contain, in the metadata, information indicating whether the image signal is the RAW image. Further, assume that the image signal output from the output apparatus A does not contain, in the metadata, information indicating whether an operation of the output apparatus A is a live view (LV) mode of outputting a live view image while recording the image or a playback mode of playing back and outputting the image stored in a storage medium inside the output apparatus A. Therefore, the information for determining that the image signal output from the output apparatus A is the non-RAW image is that the pixel value of each pixel is the YCbCr format.

Assume that the output apparatus B specifies the pixel value of each pixel in the RGB format if outputting the image signal of the RAW image, and specifies the pixel value of each pixel in the YCbCr format in some cases and specifies the pixel value of each pixel in the RGB format in other cases if outputting the image signal of the non-RAW image. Further, assume that the image signal output from the output apparatus B does not contain, in the metadata, the information indicating whether the image signal is the RAW image. Further, assume that the image signal output from the output apparatus B contains, in the metadata, information indicating whether an operation of the output apparatus B is the LV mode or the playback mode. Therefore, the information for determining that the image signal output from the output apparatus B is the non-RAW image is that the pixel value of each pixel is the YCbCr format, or the pixel value of each pixel is the RGB format and an operation state of the output apparatus B is the play mode.

Assume that the output apparatus C specifies the pixel value of each pixel in the RGB format if outputting the image signal of the RAW image, and specifies the pixel value of each pixel in the YCbCr format in some cases and specifies the pixel value of each pixel in the RGB format in other cases if outputting the image signal of the non-RAW image. Further, assume that the image signal output from the output apparatus C does not contain, in the metadata, the information indicating whether the image signal is the RAW image. Further, assume that the image signal output from the output apparatus C does not contain, in the metadata, information indicating whether an operation of the output apparatus C is the LV mode or the playback mode.

On the other hand, the time code information indicating the time at which the image is acquired is contained in the metadata output from the output apparatus C. The time code information indicates a time close to a current time if the operation of the output apparatus C is the LV mode. On the other hand, the time code information indicates a time earlier than the current time if the operation of the output apparatus C is the playback mode. Therefore, the information for determining that the image signal output from the output apparatus C is the non-RAW image is that the pixel value of each pixel is the YCbCr format, or the pixel value of each pixel is the RGB format and the time indicated by the time code information is a time in the past. For example, assume that the image signal output from the output apparatus C is determined to be the non-RAW image if the time indicated by the time code information is a time earlier than the current time when the determination is made by a predetermined or longer time period.

Assume that the output apparatus D specifies the pixel value of each pixel in the YCbCr format both when outputting the image signal of the RAW image and when outputting the image signal of the non-RAW image. Further, assume that the image signal output from the output apparatus D does not contain, in the metadata, the information indicating whether the image signal is the RAW image. Further, assume that the image signal output from the output apparatus D does not contain, in the metadata, information indicating whether an operation of the output apparatus D is the LV mode of outputting the live view image while recording the image or the playback mode of playing back and outputting the image stored in a storage medium inside the output apparatus D.

On the other hand, assume that the output apparatus D transmits the image signal in a signal format in compliance with the Three-dimensional (3D)-SDI standard (a 3D-SDI format) if outputting the image signal of the RAW image. Further, assume that the output apparatus D transmits the image signal in a signal format in compliance with the High Definition (HD)-SDI standard (an HD-SDI format) if outputting the image signal of the non-RAW image. Therefore, the information for determining that the image signal output from the output apparatus D is the non-RAW image is that the image signal is the signal in the format in compliance with the HD-SDI standard.

Assume that the output apparatus E specifies the pixel value of each pixel in the YCbCr format both when outputting the image signal of the RAW image and when outputting the image signal of the non-RAW image. Further, assume that the metadata is contained in the image signal if the image signal output from the output apparatus E is the RAW image. Further, assume that the image signal output from the output apparatus E does not contain, in the metadata, information indicating whether an operation of the output apparatus E is the LV mode of outputting the live view image while recording the image or the playback mode of playing back and outputting the image stored in a storage medium inside the output apparatus E. Therefore, the information for determining that the image signal output from the output apparatus E is the non-RAW image is that the metadata is not contained in the image signal.

Assume that the output apparatus F can output the image signal in which the pixel value of each pixel is specified in the RGB format or the YCbCr format both when outputting the image signal of the RAW image and when outputting the image signal of the non-RAW image. Further, assume that the image signal output from the output apparatus F contains, in the metadata, the information whether the image signal is the RAW image. Further, assume that the image signal output from the output apparatus F contains, in the metadata, the information indicating whether an operation of the output apparatus F is the LV mode or the playback mode. However, the output apparatus F can output the image signal of the RAW image even when operating in the playback mode. Therefore, the information for determining that the image signal output from the output apparatus F is the non-RAW image is the information indicating whether the image signal is the RAW image that is contained in the metadata.

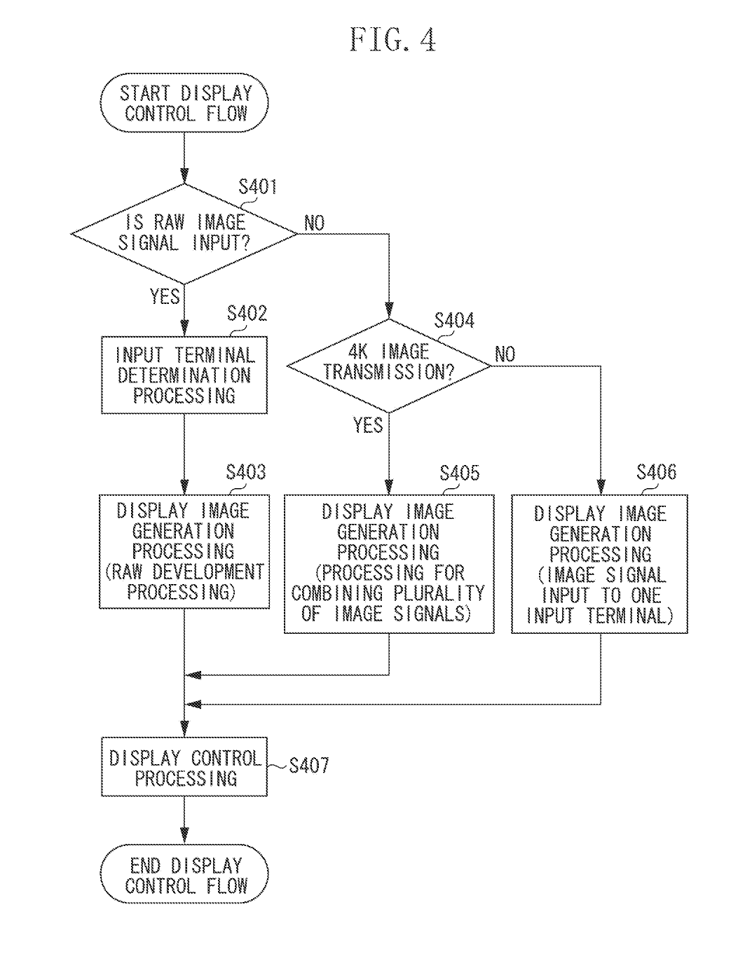

A display image output procedure performed by the display apparatus 200 will be described with reference to FIG. 4. FIG. 4 is a flowchart illustrating the display image output procedure performed by the display apparatus 200.

This procedure will be described referring to an example in a case where the display apparatus 200 is set so as to carry out the RAW development to generate the display image if any of the image signals a to d generated and output by the output apparatus 100 is the image signal of the RAW image.

Assume that display control processing is started when the video signal is input to each of the input terminals 201a to 201d or when the user instructs the display apparatus 200 to display the image. Further, assume that the terminal determination unit 204 has determined that the output apparatus 100 has been a model corresponding to the output apparatus A based on the metadata acquired from the signal separation unit 202. Therefore, according to FIG. 3, the information used for the terminal determination unit 204 to determine whether the image signal is the non-RAW image is that the pixel value of each pixel in the image signal is the YCbCr format.

In step S401, the terminal determination unit 204 determines whether the RAW signal is input to any of the four input terminals 201a to 201d. The terminal determination unit 204 determines whether the input image signal is the RAW image based on the acquired metadata. More specifically, the terminal determination unit 204 is assumed to determine whether the input image signal contains the image data in which the pixel value is specified in RGB, based on the information indicating the format for specifying the color of the pixel that is contained in the metadata. In a case where the pixel value of each pixel in the input image signal is the YCbCr format, the terminal determination unit 204 determines that the image signal is not the RAW image (NO in step S401). The processing proceeds to step S403. On the other hand, if the pixel value of each pixel in the input image signal is the RGB format, the terminal determination unit 204 determines that the image signal is the RAW image (YES in step S401). The processing proceeds to step S402.

In step S402, the terminal determination unit 204 determines the input terminal for acquiring the image signal to be used to generate the display image. The terminal determination unit 204 determines the input terminal for acquiring the image signal to be used to generate the display image with use of the information indicating the order or the terminal information contained in the metadata. The terminal determination unit 204 may select the input terminal by referring to a determination table stored in advance. The determination table stores therein information indicating an input terminal usable to generate the display image that corresponds to the original image, if the RAW image is output. Alternatively, the display control unit 205 may be configured to analyze the image signal and select each of input terminals to which image signals formed from different images are input. The processing proceeds to step S403.

In step S403, the display control unit 205 performs the RAW development processing on the image signal input to the determined input terminal, thereby performing processing for generating the display image.

In step S404, the terminal determination unit 204 determines whether a plurality of image signals is input to the plurality of input terminals 201a to 201d. More specifically, the terminal determination unit 204 determines whether at least one of the input image signals is different from the other image signals. At least one of the input image signals is different from the other image signals, for example, when a 4 thousands (4K) (3840×2160) image is transmitted as the image signal of the non-RAW image (4K image transmission). In a case where the image transmission is the 4K image transmission (YES in step S404), the processing proceeds to step S405.

Now, assume that the terminal determination unit 204 can determine that the image transmission is the transmission of the 4K image if image signals different from one another are input to three or more terminals. Further, the terminal determination unit 204 can also determine whether same HD video images are input or different video images are input based on the metadata. The display control unit 205 can also make this determination by analyzing the image signal.

In step S405, the display control unit 205 determines that all of the input terminals to which the 4K image is transmitted are each the input terminal to be used to generate the display image, and generates the display image with use of all of the image signals input to these input terminals.

On the other hand, the terminal determination unit 204 determines that the image transmission is the HD transmission in step S404 (NO in step S404) in a case where same image signals as one another are input to the plurality of input terminals 201a to 201d. Then, the processing proceeds to step S406. In step S406, the display control unit 205 determines that one arbitrary input terminal among the plurality of input terminals 201a to 201d is the input terminal to be used to generate the display image, and generates the display image based on the image signal input to this input terminal.

In step S407, the display control unit 205 controls the display unit 206 in such a manner that the image is displayed based on the generated display image.

According to the above-described display apparatus, it becomes possible to determine the input terminal for acquiring the image signal to be used to generate the display image, according to whether the plurality of image signals input via the plurality of input terminals is the RAW image. Therefore, the above-described configuration allows the display apparatus including the plurality of input terminals to switch the transmission path necessary to generate the image for the display according to a change in the data format of the input image.

According to the above-described processing, the switching between the RAW signal and the non-RAW image is determined based on the meta signal or whether the transmitted signal is RGB or YCbCr. Further, it becomes possible to automatically switch the terminal for receiving the image signal to be used for the display without the user's operation input, by automatically identifying which terminal the signal that should be used has been transmitted through and automatically selecting the RAW development and the display terminal.

In the present embodiment, the display apparatus identifies the method for determining whether the image signal is the RAW image, based on the information indicating the model of the output apparatus that is contained in the metadata superimposed on the image signal, but the method for identifying the model of the output apparatus is not limited thereto. For example, the model of the output apparatus can also be identified by displaying a graphical user interface (GUI) for selecting the type of the output apparatus written in the determination table stored in the memory on the display unit of the display apparatus and causing the user to operate the GUI via the operation member provided on the display apparatus. Further, the user can also directly input the method for determining whether the image signal is the RAW image with use of the GUI or the operation member, instead of the type of the output apparatus.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2017-046562, filed Mar. 10, 2017, which is hereby incorporated by reference herein in its entirety.

What is claimed is:

1. A display apparatus comprising:
a display unit configured to display an image;
a plurality of input terminals configured to input a plurality of image signals; and
a control unit configured to control the display unit,
wherein, in a case where at least one of the plurality of image signals is of a Raw Image Format (RAW) image, the control unit controls the display unit to display the image based on an image signal input to an input terminal among the plurality of input terminals that corresponds to a first number, and
wherein, in a case where none of the plurality of image signals is of a RAW image, the control unit controls the display unit to display the image based on an image signal input to an input terminal among the plurality of input terminals that corresponds to a second number.

2. The display apparatus according to claim 1, wherein, in a case where metadata added to at least one of the plurality of image signals contains information indicating that an image signal input to the input terminal corresponding to the first number is of the RAW image, the control unit controls the display unit to display the image based on the image signal input to the input terminal corresponding to the first number.

3. The display apparatus according to claim 1, wherein, in a case where a pixel value of each of the plurality of image signals is expressed in Red, Green, and Blue (RGB), the control unit controls the display unit to display the image based on the image signal input to the input terminal corresponding to the first number.

4. The display apparatus according to claim 1, wherein, in a case where a time code added to at least one of the plurality of image signals represents a time that is earlier, by a predetermined or longer time period, than a time when a determination of whether an image signal of a RAW image is made, the control unit controls the display unit to display the image based on the image signal input to the input terminal corresponding to the second number.

5. The display apparatus according to claim 1, wherein, in a case where a data format of at least one signal among the plurality of image signals is a Three-dimensional-Serial Digital Interface (3D-SDI) format, the control unit controls the display unit to display the image based on the image signal input to the input terminal corresponding to the second number.

6. The display apparatus according to claim 1, wherein, in a case where metadata is added to all of the plurality of image signals, the control unit controls the display unit to display the image based on the image signal input to the input terminal corresponding to the first number.

7. The display apparatus according to claim 1,
wherein, in a case where none of the plurality of image signals is of a RAW image and the plurality of image signals is same image signals, the control unit controls the display unit to display the image based on the image signal input to any one of the plurality of input terminals, and
wherein, in a case where none of the plurality of image signals is of a RAW image and image signals of the plurality of image signals are different image signals, the control unit controls the display unit to display the image based on the plurality of image signals input to the plurality of input terminals.

8. The display apparatus according to claim 1,
wherein the control unit sets a determination condition for determining whether the input image signal is of a RAW type according to a type of an output apparatus that outputs the plurality of image signals, and
wherein the control unit determines whether the input image signal is of a RAW image based on the set determination condition and the input image signal.

9. The display apparatus according to claim 1, wherein the first number and the second number are different from each other.

10. A display apparatus comprising:
a display unit;
a plurality of input terminals connected to an output apparatus and configured to acquire a plurality of image signals output from the output apparatus; and
a control unit configured to control the display unit to display an image based on an image signal input to at least one input terminal among the plurality of input terminals,
wherein, in a case where the input image signal is an image signal of a predetermined type, the control unit selects, among the plurality of input terminals, an input terminal corresponding to a predetermined number and controls the display unit to display the image based on the image signal of the predetermined type, and
wherein, in a case where the input image signal is an image signal not of the predetermined type, the control unit selects, among the plurality of input terminals, an input terminal corresponding to a number that is different from predetermined number and controls the display unit to display the image based on the image signal not of the predetermined type.

11. The display apparatus according to claim 10,
wherein the control unit sets a determination condition for determining whether the input image signal is an image signal of a predetermined type according to the type of the output apparatus, and
wherein the control unit determines whether the input image signal is of the predetermined type based on the set determination condition and the input image signal.

12. A method for controlling a display apparatus having a display unit configured to display an image, and a plurality of input terminals configured to input a plurality of image signals, the method comprising:
controlling, in a case where at least one of the plurality of image signals is of a Raw Image Format (RAW) image, the display unit to display the image based on an image signal input to an input terminal among the plurality of input terminals that corresponds to a first number; and
controlling, in a case where none of the plurality of image signals is of a RAW image, the display unit to display the image based on an image signal input to an input terminal among the plurality of input terminals that corresponds to a second number.

13. The method according to claim 12,
wherein, in a case where none of the plurality of image signals is of a RAW image and the plurality of image signals is same image signals, controlling includes controlling the display unit to display the image based on the image signal input to any one of the plurality of input terminals, and
wherein, in a case where none of the plurality of image signals is of a RAW image and image signals of the plurality of image signals are different image signals, controlling includes controlling the display unit to display the image based on the plurality of image signals input to the plurality of input terminals.

14. The method according to claim 12,
wherein controlling includes setting a determination condition for determining whether the input image signal is of a RAW type according to a type of an output apparatus that outputs the plurality of image signals, and
wherein controlling includes determining whether the input image signal is of a RAW image based on the set determination condition and the input image signal.

15. The method according to claim 12, wherein the first number and the second number are different from each other.

16. A method for controlling a display apparatus having a display unit, and a plurality of input terminals connected to an output apparatus and configured to acquire a plurality of image signals output from the output apparatus, the method comprising:
controlling the display unit to display an image based on an image signal input to at least one input terminal among the plurality of input terminals,
wherein, in a case where the input image signal is an image signal of a predetermined type, controlling includes selecting, among the plurality of input terminals, an input terminal corresponding to a predetermined number and controlling the display unit to display the image based on the image signal of the predetermined type, and
wherein, in a case where the input image signal is an image signal not of the predetermined type, controlling includes selecting, among the plurality of input terminals, an input terminal corresponding to a number that is different from predetermined number and controlling the display unit to display the image based on the image signal not of the predetermined type.

17. The method according to claim 16,
wherein controlling includes setting a determination condition for determining whether the input image signal is an image signal of a predetermined type according to the type of the output apparatus, and
wherein controlling includes determining whether the input image signal is of the predetermined type based on the set determination condition and the input image signal.

18. A non-transitory computer-readable storage medium storing a program to cause a computer to perform a method for controlling a display apparatus having a display unit configured to display an image, and a plurality of input terminals configured to input a plurality of image signals, the method comprising:
controlling, in a case where at least one of the plurality of image signals is of a Raw Image Format (RAW) image, the display unit to display the image based on an image signal input to an input terminal among the plurality of input terminals that corresponds to a first number; and
controlling, in a case where none of the plurality of image signals is of a RAW image, the display unit to display the image based on an image signal input to an input terminal among the plurality of input terminals that corresponds to a second number.

19. A non-transitory computer-readable storage medium storing a program to cause a computer to perform a method for controlling a display apparatus having a display unit, and a plurality of input terminals connected to an output apparatus and configured to acquire a plurality of image signals output from the output apparatus, the method comprising:
controlling the display unit to display an image based on an image signal input to at least one input terminal among the plurality of input terminals,
wherein, in a case where the input image signal is an image signal of a predetermined type, controlling includes selecting, among the plurality of input terminals, an input terminal corresponding to a predetermined number and controlling the display unit to display the image based on the image signal of the predetermined type, and
wherein, in a case where the input image signal is an image signal not of the predetermined type, controlling includes selecting, among the plurality of input terminals, an input terminal corresponding to a number that is different from predetermined number and controlling the display unit to display the image based on the image signal not of the predetermined type.
